(19) United States
(12) Patent Application Publication
(10) Pub. No.: US 2009/0125474 A1
(43) Pub. Date: May 14, 2009

(54) USER PREFERENCE-BASED DATA ADAPTATION SERVICE SYSTEM AND METHOD

(75) Inventors: Jong Won Kim, Gwangju (KR); Young-Koo Lee, Yongin-si (KR); Yongkoo Han, Yongin-si (KR)

Correspondence Address: AMPACC LAW GROUP, 13024 Beverly Park Road, Suite 205, Mukilteo, WA, 98275, US

(73) Assignee: Gwangju Institute of Science and Technology, Gwangju (KR)

(21) Appl. No.: 12/265,329

(22) Filed: Nov. 5, 2008

(30) Foreign Application Priority Data
Nov. 9, 2007 (KR) 10-2007-0114496

(51) Int. Cl. G06N 5/02

(52) U.S. Cl. 706/55

(57) ABSTRACT

The present invention relates to a user preference-based data adaptation service system and method. More particularly, the present invention relates to a user preference-based data adaptation service system and method capable of providing a data adaptation service that appropriately converts a file in consideration of a difference between the platforms of different kinds of devices in order to share the file, and reflecting an exact user preference in consideration of the surrounding environments, such as, the performance of the device and a network.

### BACKGROUND OF THE INVENTION

1. Field of the Invention

The present invention relates to a user preference-based data adaptation service system and method. More particularly, the present invention relates to a user preference-based data adaptation service system and method capable of providing a data adaptation service that appropriately converts a file in consideration of a difference between the platforms of different kinds of devices in order to share the file, and reflecting an exact user preference in consideration of the surrounding environments, such as the performance of a device and a network.

2. Description of the Related Art

The term ‘ubiquitous’ is the Latin language meaning ‘something being or seeming to be everywhere at the same time’ while transcending time and space, such as water or air. In addition, the term ‘ubiquitous’ means an information communication environment in which a user can access a network anywhere, regardless of the types of computers networks. With the development of networking and multimedia techniques, the ubiquitous environment enables the users in different places to conveniently participate in remote discussion or conference.

With the development of the ubiquitous environment, the necessity for multi-party remote collaboration has increased in, for example, companies, research institutes, and schools. It is very important to share files among constituent members in order to effectively communicate with each other during the remote collaboration. In the collaboration environment, the users want to share files having different formats and sizes. In order to perform filing sharing, a service that adapts or converts data in consideration of a difference between the platforms of different kinds of devices is certainly needed.

Many studies have been conducted in order to effectively and efficiently provide a data adaptation service. A. Fox and E. Brewer have conducted studies on three-dimensional client contexts, such as a network, hardware, and software. In the studies, a data adaptation system applies optimum data adaptation in consideration of the three-dimensional client contexts, or selects a data version that has been made beforehand. However, since the studies do not consider user's preference, it is difficult for the user to select a desired data version.

Meanwhile, J. Chen, Y. Yang, and H. Zhang have conducted studies on a score-based estimation method in which, in order to determine the optimum data adaptation method among various data adaptation methods, a score including user's preference is assigned to each adaptation method. However, in this case, the user needs to manually assign the score, which is unuseful and inefficient.

In the collaboration environment, the data adaptation service needs to certainly consider real-time environmental contexts, such as user's preference, a device performance, a network bandwidth, and a file size, in order to effectively and efficiently perform file sharing. If the data adaptation service considers only the device performance, the service can accept the device performance, but may not perform real-time transmission due to environmental factors, such as restrictions in the network bandwidth. In addition, when the service can accept the device performance and a network environment but does not satisfy user demands, or when more detailed data than that the user requests is transmitted, a transmission delay or a waste of resources may occur. Therefore, a data adaptation service that reflects exact user preference while considering the surrounding environments, such as a device performance and a network bandwidth, is needed.

### SUMMARY OF THE INVENTION

The invention has been made in order to solve the above problems, and an object of the invention is to provide a user preference-based data adaptation service system and method capable of reflecting exact user preference while considering the surrounding environments, such as a device performance and a network bandwidth.

According to an aspect of the invention, there is provided a user preference-based data adaptation service system that receives an original file and converts the original file. The system includes: a storage that stores user profile parameters including a user preference value, device profile information, and environmental context information; a decision engine that reads the user preference value from the storage to generate preference similar nodes, arranges the preference similar nodes according to preference similarity values, and determines a preference similar node that has the highest preference similarity value while satisfying the device profile information and the environmental context information; and a data converting unit that converts the original file according to the preference similar node determined by the decision engine.

The decision engine may include: a user preference value reading unit that reads the user preference value stored in the storage beforehand; a preference similar node generating unit that generates the preference similar nodes from the user preference value read by the user preference value reading unit, and arranges the preference similar nodes in descending order of the preference similarity values; and a preference similar node selecting unit that selects the preference similar node having the highest preference similarity among the preference similar nodes that are arranged in the descending order of the preference similarity values by the preference similar node generating unit.

The decision engine may further include a first determining unit that determines whether the performance of a target device can accept the adaptation setting of a specific preference similar node selected by the preference similar node selecting unit.

The decision engine may further include a second determining unit that determines whether the preference similar node selected by the preference similar node selecting unit satisfies the environmental contexts.

The preference similar node generating unit may include: a user preference calculating unit that calculates a user preference from the user preference value; a adaptation setting preference calculating unit that generates all available preference similar nodes from each quality dimension according to the quality value, and calculates adaptation setting preferences of all of the generated preference similar nodes using the quality value; a preference similarity calculating unit that calculates the preference similarities of all the preference similar nodes from the user preference calculated by the user preference calculating unit and the adaptation setting preference calculated by the adaptation setting preference calculating unit; and a preference similar node arranging unit that arranges all the preference similar nodes in the descending order of the preference similarity on the basis of the preference similarity calculated by the preference similarity calculating unit.

The preference similarity calculating unit may calculate an angle formed between a vector indicating the user preference and a vector indicating the adaptation setting preference as the preference similarity.

According to another aspect of the invention, there is provided a method of providing a user preference-based data adaptation service. The method includes: allowing a user to input a user preference value for each quality dimension; calculating a user preference from the input user preference value to generate preference similar nodes, calculating the preference similarity of each preference similar node, and arranging the preference similar nodes in descending order of the preference similarity; and selecting a preference similar node having the highest preference similarity among the generated and arranged preference similar nodes.

The method may further include determines whether the performance of a target device can accept the adaptation setting of the selected preference similar node.

The method may further include: when it is determined that the performance of the target device does not accept the adaptation setting of the selected preference similar node, returning to the selecting of the preference similar node to select a preference similar node having the next highest preference similarity; and repeating the determination and the selection of preference similar node.

The method may further include determining whether the preference similar node, which has been determined to be accepted by the target device, satisfies an environmental context.

According to the above-mentioned aspects of the invention, it is possible to provide a data adaptation service that appropriately converts a file in consideration of a difference between the platforms of different kinds of devices in order to share the file, and reflect an exact user preference in consideration of the surrounding environments, such as, the performance of the device and a network.

Further, the above-mentioned aspects of the invention can be applied to real-time file sharing and data download in addition to a remote collaboration environment to improve data exchange efficiency between different kinds of devices and user satisfaction.

### BRIEF DESCRIPTION OF THE DRAWINGS

FIG. 1 is a block diagram illustrating a user preference-based data adaptation service system according to an embodiment of the invention;

FIG. 2 is a detailed block diagram illustrating a decision engine shown in FIG. 1;

FIG. 3 is a detailed block diagram illustrating a preference similar node generating unit shown in FIG. 2; and

FIG. 4 is a flowchart illustrating a method of providing a user preference-based data adaptation service according to another embodiment of the invention.

### DESCRIPTION OF THE PREFERRED EMBODIMENTS

Hereinafter, exemplary embodiments of the invention will be described in detail with reference to the accompanying drawings. First, the same elements will be designated by the same reference numerals all through the following description and drawings although they are shown in different drawings. Further, in the following description of the present invention, a detailed description of known functions and configurations incorporated herein will be omitted when it may make the subject matter of the present invention rather unclear. Further, although exemplary embodiments of the invention will be described below, the technical ideas of the invention is not limited thereto, but various modifications and changes of the invention can be made by those skilled in the art.

First, a user preference-based data adaptation service system according to an exemplary embodiment of the invention will be described.

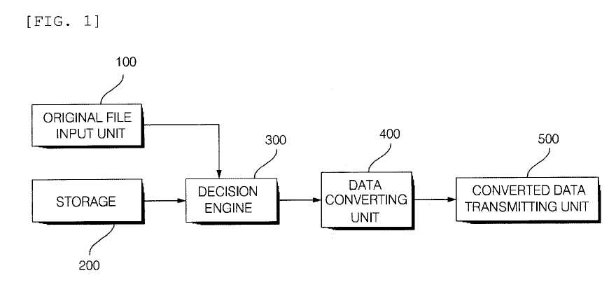

FIG. 1 is a block diagram illustrating the user preference-based data adaptation service system according to the embodiment of the invention.

Referring to FIG. 1, the user preference-based data adaptation service system includes an original file input unit 100, a storage 200, a decision engine 300, a data converting unit 400, and a converted data transmitting unit 500.

The original file input unit 100 inputs the original file to be shared by constituent members in a multi-party collaboration environment, and information on the original file (for example, a file manufacturer ID). In this case, the format of the original file is not particularly limited, and all files to be shared by the constituent members, such as image files, moving picture files, audio files, text files, program operating files, may correspond to the original file. Various original files may be configured according to, for example, a size, a format type, the platform of generated hardware, and user's preference. It is preferable to convert the original file into an appropriate format for sharing between different kinds of devices. In addition, it is preferable that the user receives a file having a format to which user's preference is reflected rather than receive the original file without any change, in order to improve usability and satisfaction. Therefore, the decision engine 300 determines the optimum file adaptation setting of the original file input through the original file input unit 100 in consideration of, for example, user preference, a device performance, and environmental context. Then, the data converting unit 400 converts the original file into a desired file format. The original file input unit 100 may receive the original file from an external network through wire/wireless transmission media, or it may be an input device of a terminal, such as a keyboard, a mouse, a scanner, a camera, or a microphone. However, the input type is not limited thereto.

The storage repository 200 stores all user profile parameters for determining the optimum file adaptation setting, such as user information, user's preference, device profile information, and environmental context information. It is preferable that the user profile parameters be stored in the storage 200 beforehand such that, when a specific constituent member connected to the network requests the transmission of a specific file, the file can be converted into a format suitable for the preference of the specific constituent member, a device performance, and environmental context and the converted file can be immediately transmitted.

The user profile parameters include user information, user's preference, device profile information, and environmental context information.

The user information is for identifying constituent members who want to use a file sharing service in the multi-party collaboration environment, and corresponds to ID information, such as user IDs. The user's preference is an attribute in a specific file capable of providing the user with the highest satisfaction. For example, when a specific user wants a classified color step rather than an exact scale in the specific image file, a larger weight value is allocated to the color attribute. In this case, the weight value corresponds to the user preference. The device profile information is for determining whether a specific user device (hereinafter, referred to as a “target device”) can accept the file adaptation setting that is selected on the basis of the user preference. For example, when an image file is converted into a specific resolution according to the user preference, the target device of the user should accept the resolution in order to perform the file adaptation. The environmental context information is a factor that has an effect on the real-time transmission of files, such as a file size or a network bandwidth. For example, when the user wants to receive a file having a specific size, a memory buffer of the target device that requests the transmission of the files should have capacity that is larger than at least the file size in order to receive the file. When a specific user requests file sharing, these parameters stored in the storage 200 are transmitted to the decision engine 300 in order to determine file adaptation setting that satisfies the request.

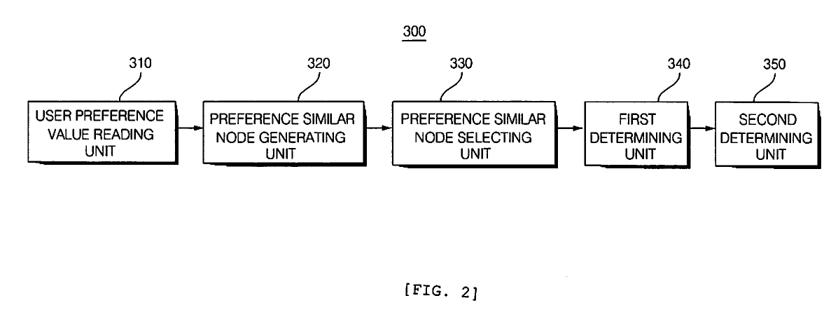

The decision engine 300 reads out a user profile parameter from the storage 200, determines a data adaptation method most suitable for converting the original file received from the original file input unit 100 on the basis of the read parameter, and transmits the determined data adaptation method to the data converting unit 400. In order to determine the optimum data adaptation method, the decision engine 300 uses a preference-based estimation method to determine the optimum data adaptation setting. The decision engine 300 extracts a user preference value from the storage 200 to calculate a user preference, generates a preference similar node that is most similar to the user preference, and selects the optimum preference similar node with reference to the device profile information and the environmental context information stored in the storage 200 on a rule basis. The detailed structure of the decision engine 300 will be described below with reference to FIG. 2.

The data converting unit 400 converts the original file according to the data adaptation method determined by the decision engine 300, and transmits the version of the generated file to the converted data transmitting unit 500. In the data converting unit 400, a set of a plurality of unit converters is configured by combinations of the selected preference similar node, the rule-based device profile information, and the environmental context information.

The converted data transmitting unit 500 transmits the data converted by the data converting unit 400 to the user device that requests the file. In this case, the converted data may be transmitted by various means, such as wire/wireless LANs.

FIG. 2 is a detailed block diagram illustrating the decision engine shown in FIG. 1.

The decision engine 300 performs preference-based estimation using the concept of preference similarity indicating that an arbitrary content version of a file is more suitable than the others, in order to numerically determine adaptation setting or a content version, which is a file that is converted from the original file into a different quality dimension value, thereby determining the optimum data adaptation setting. Next, some concepts for designing the preference-based estimation system will be defined.

\textcircled{1} Quality Dimension

A quality dimension is defined as an attribute that determines the adaptation of a file having a specific format. The quality dimensions can be bound with all other attributes having a specific file format. For example, an image file may be represented by 3 quality dimensions, such as (qd imagefile)=(color, scaling, sharpness). In this case, ‘color’ means the color of the image file, ‘scaling’ means the scale of the image file, and ‘sharpness’ means the shape of the image file.

\textcircled{2} Adaptation Setting

The adaptation setting is quality dimension tuple, and is composed of a combination of values for each quality dimension. For example, when an i quality dimension value is qsi, the adaptation setting is represented by a vector <qs1, qs2, . . . , qsi>.

\textcircled{3} Quantization Step

The quantization step is defined as the steps of values that can be accepted by a specific quality dimension. For example, the color, which is one of the quality dimensions in the image file, may be scaled to 1 bit, 8 bits, or 24 bits, and the quantization step means the step of each scale.

\textcircled{4} Quality Value

The quality value is defined as a numerical value indicating the difference between the original file and the quantization step in the quality dimension. The quality value is calculated by a quality value modeling function, and may be in a range of 0 to 1. As the quality value is closer to 1, the quantization step is more similar to the original file.

A quality value modeling function f is a modeling function for a quality value qv corresponding to a quantization step qs. The modeling function f for an i-th quality dimension is represented by qv=fi(qs). In order to monitor a variation of qv with respect to qs, first modeling and second modeling may be used.

A linear quality value modeling function may be expressed by Equation 1 given below:

$$qv = \frac{qs - {qs}_{min}}{{qs}_{max} - {qs}_{min}} \qquad [ Equation 1 ]$$

(where qsₘₐₓ indicates a maximum step that is available in the quality dimension (for example, 100% scale value), and qsₘᵢₙ indicates a minimum step that is available in the quality dimension (for example, 1% or 2% scale value)).

A quadratic quality value modeling function may be represented by a modeling curve that is expressed by a quadratic equation, such as Equation 2 given below:

qv=aqs²+bqs+c. [Equation 2]

The user uses the concept of the quantization step and the quality value to easily represent user's preference. For example, when the user prefers the scale to the color in the image file, the user assigns a small scale value to the color in the quantization step qs.

\textcircled{5} Adaptation Setting Preference

The adaptation setting preference is normalized values of quality values <qv1, qv2, . . . , qvi> in each dimension. The adaptation setting preference may have a value in a range of 0 to 1. As the adaptation setting preference is closer to 1, the similarity to the original file increases. In i quality dimensions, the adaptation setting preference adaptation function may be expressed by Equation 3 given below:

Pai(<qs1, qs2, . . . , qsi>)=<f1(qs1), f2(qs2), . . . , fi(qsi)>. [Equation 3]

\textcircled{6} User Preference Value

The user preference value is defined as preference that is assigned to each quality dimension by the user, and is in a range of 0 to 1. The i quality dimensions are represented by (u1, u2, . . . , ui).

\textcircled{7} User Preference

The user preference is a normalized value of the user preference value. In n quality dimensions, a specific i-dimensional user preference Pui is represented by Pui=ui/(u1, u2, . . . , un).

\textcircled{8} Preference Similarity

The preference similarity is defined as similarity between the adaptation setting preference and the user preference, and the optimum data adaptation setting is determined by the preference similarity. Since the preferences are represented by n-dimensional vectors, the similarity between two vectors is determined by the angle formed between the two vectors. The similarity, which is the magnitude of the angle between the vectors Pa and Pu, can be defined by Equation 4 given below:

$$Similarity ( \vec{Pa} , \vec{Pu} ) = \frac{\vec{Pa} \cdot \vec{Pu}}{\vert \vec{Pa} \vert \cdot \vert \vec{Pu} \vert} . \qquad [ Equation 4 ]$$

One preference similarity may be one data adaptation setting, and each data adaptation setting is defined as a preference similar node as follows.

\textcircled{9} Preference Similar Node

The preference similar node is defined as adaptation settings having different preference similarity values. For example, when there are five quality dimensions for allowing the user to determine the preference and each quality dimension has four adaptation setting preferences (that is, four kinds of qs values and four kinds of qv values), there are 4⁵ (=1024) preference similar nodes in a search space.

The search space is composed of all available preference similar nodes that are generated in an initial stage. These preference similar nodes include all available adaptation settings that can be generated by the decision engine.

The preference similarity value makes it possible to numerically determine a content version or the corresponding adaptation setting. For example, when the user assigns user preference values of 0.2, 0.4, and 0.5 to three quality dimensions, the user preference is Pu=(2/11, 4/11, 5/11). When a specific preference similar node has a quality value qv of (f1(qs), f2(qs), f3(qs)=(0.5, 0.9, 0.2), the adaptation setting preference of the node is Pa=(5/16, 9/16, 2/16). Therefore, the preference similarity of the preference similar node is represented by Equation 5:

$$Similarity ( \vec{Pa} , \vec{Pu} ) = \frac{( \begin{matrix}\frac{5}{16} \cdot \frac{2}{11} + \frac{9}{16} \cdot \\ \frac{4}{11} + \frac{2}{16} \cdot \frac{5}{11}\end{matrix} )}{\begin{matrix}\sqrt{{( \frac{5}{16} )}^{2} + {( \frac{9}{16} )}^{2} + {( \frac{2}{16} )}^{2}} \cdot \\ \sqrt{{( \frac{2}{11} )}^{2} + {( \frac{4}{11} )}^{2} + {( \frac{5}{11} )}^{2}}\end{matrix}} . \qquad [ Equation 5 ]$$

As such, the preference similarity of each preference similar node is calculated, and it is determined whether the preference similar node having the largest value can accept a device and satisfy the environmental context. Then, data adaptation is performed according to the finally determined data adaptation method.

Referring to FIG. 2, the decision engine 300 includes a user preference value reading unit 310, a preference similar node generating unit 320, a preference similar node selecting unit 330, a first determining unit 340, and a second determining unit 350.

The user preference value reading unit 310 reads the user preference value that has been stored in the storage 200 beforehand. As defined above, the user preference value is assigned to each quality dimension by the user. Each user, who is a constituent member of the multi-party collaboration environment, classifies the quality dimensions according to user preference, digitizes the classified quality dimensions, and stores the user preference values in the storage 200 beforehand. For example, in i quality dimensions, the user preference value is represented by (u1, u2, . . . , ui).

The preference similar node generating unit 320 calculates the user preference from the user preference value read from the user preference value reading unit 310, and generates all preference similar nodes that can be combined according to the adaptation setting preference from each quality dimension. Then, the preference similar node generating unit 320 uses the user preference and the quality value of each preference similar node to calculate the preference similarity and arranges the preference similarities in descending order.

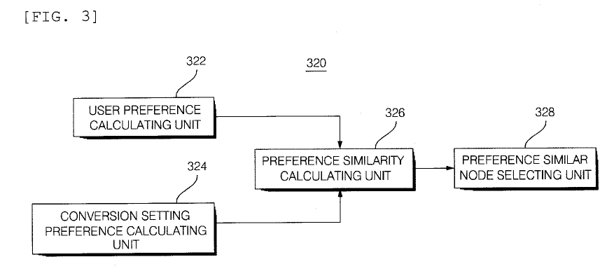

FIG. 3 is a detailed block diagram illustrating the preference similar node generating unit 320.

Referring to FIG. 3, the preference similar node generating unit 320 includes a user preference calculating unit 322, a adaptation setting preference calculating unit 324, a preference similarity calculating unit 326, and a preference similar node arranging unit 328.

The user preference calculating unit 322 calculates user preference from the user preference value. The user preference is a normalized value of the user preference value that has been stored in the storage 200 beforehand. In n quality dimensions, a specific i-dimensional user preference is represented by Pui=ui/(u1, u2, . . . , un).

The adaptation setting preference calculating unit 324 generates all available preference similar nodes from each quality dimension according to the quality value, and calculates the adaptation setting preferences of all the generated preference similar nodes using the quality value qv. For example, when there are three quality dimensions, each having five adaptation setting preferences, a total of 5³ (=125) preference similar nodes are generated, and thus 125 adaptation setting preferences are calculated.

The preference similarity calculating unit 326 calculates the preference similarities of all the preference similar nodes using the user preference calculated by the user preference calculating unit 322 and the adaptation setting preference calculated by the adaptation setting preference calculating unit 324. In this case, as described above, the preference similarity is defined as the angle formed between the user preference vector and the adaptation setting preference vector.

The preference similar node arranging unit 328 arranges the preference similarities of all the preference similar nodes in descending order of the preference similarity on the basis of the preference similarity calculated by the preference similarity calculating unit 326. Then, it is determined whether the preference similar nodes that are arranged in the order of the preference similarity can be accepted by a device and satisfy the environmental context, and then the data adaptation method is determined.

The preference similar node selecting unit 330 selects a preference similar node having the highest preference similarity from the preference similar nodes that are arranged in the descending order of the preference similarity by the preference similar node arranging unit 328 of the preference similar node generating unit 320.

The first determining unit 340 determines whether the performance of a target device can accept the adaptation setting of a specific preference similar node selected by the preference similar node selecting unit 330. It is determined whether to accept the preference similar node by examining restrictions in the performance of the target device that is stored on the rule basis. For example, when the original file is an image file, restriction rules for the performance of the target device are as follows:
The color depth of the adaptation setting of the selected preference similar node≦the color depth of the device; and
The resolution of the adaptation setting of the selected preference similar node≦the resolution of the device.

When the first determining unit 340 determines that restrictions in the device performance are satisfied, the selected preference similar node is transmitted to the second determining unit 350. If not, the preference similar node selecting unit 330 selects a preference similar node having the next highest preference similarity, and the first determining unit 340 performs the same process as described above on the selected preference similar node.

The second determining unit 350 determines whether the selected preference similar node satisfies the environmental contexts. In this case, whether the selected preference similar node satisfies the environmental contexts is determined by examining the environmental contexts that are stored on the rule basis. The environmental contexts are factors that have an effect on the real-time reception/transmission of files, such as a file size, and a network bandwidth. For example, the determining process may be performed according to the following criteria:
The file size according to the adaptation setting of the selected preference similar node≦the size of the memory buffer of the device; and
The round trip time of packet+file size/network bandwidth<threshold time,
   (the threshold time is the maximum transmission time that can be overcome by the user in the current session).

When the second determining unit 350 determines that the selected preference similar node satisfies the environmental contexts, the selected preference similar node is transmitted to the data converting unit 400. If not, the preference similar node selecting unit 330 selects a preference similar node having the next highest preference similarity, and the first and second determining units 340 and 350 perform the same processes as described above on the selected preference similar node.

Next, a method of providing a user preference-based data adaptation service according to another embodiment of the invention will be described.

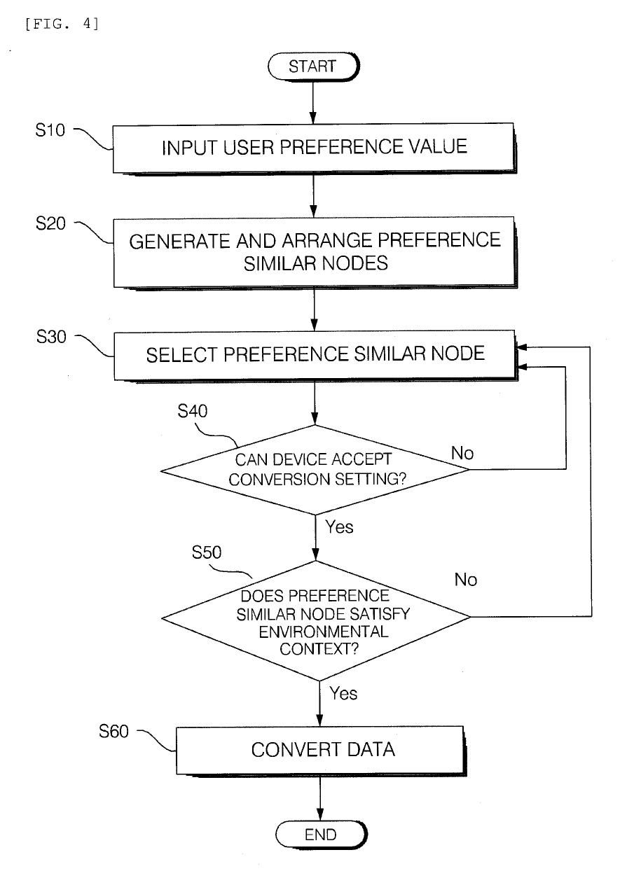

FIG. 4 is a flowchart illustrating the method of providing the user preference-based data adaptation service according to another embodiment of the invention.

Referring to FIG. 4, the method of providing the user preference-based data adaptation service according to the embodiment of the invention includes: a user preference value input step (S10), a preference similar node generating and arranging step (S20), a preference similar node selecting step (S30), a step (S40) of determining whether a device can accept adaptation setting, a step (S50) of determining whether to satisfy an environmental context, and a data adaptation step (S60).

In the user preference value input step (S10), each user who is a constituent member of the multi-party collaboration environment inputs a user preference value for each quality dimension. In i quality dimensions, the user preference value is represented by (u1, u2, . . . , ui). The user classifies the quality dimensions into quality dimensions having a large weight value and quality dimensions having a low preference level according to user preference, and inputs user preference values corresponding to the classified quality dimensions.

In the preference similar node generating and arranging step (S20), a user preference is calculated from the user preference value input in the user preference value input step (S10), and preference-based estimation is performed to generate preference similar nodes. Then, the preference similarity of each preference similar node is calculated, and the preference similar nodes are arranged in the descending order of the preference similarity. In the preference similar node generating and arranging step (S20), a preference-based estimating method is used to generate the preference similar node from the user preference value that is assigned to each quality dimension in the user preference value input step (S10). The preference similar nodes have different preference similarities. Since the highest preference similarity means the optimum adaptation setting, the preference similar nodes are arranged in the descending order of the preference similarity in order to select a preference similar node having the highest preference similarity (S30).

In the preference similar node selecting step (S30), the preference similar node having the highest preference similarity is selected from the preference similar nodes that are generated and arranged in the preference similar node generating and arranging step (S20).

In the step (S40) of determining whether a device can accept adaptation setting, it is determined whether the performance of a target device can accept the adaptation setting of the preference similar node selected in the preference similar node selecting step (S30). Whether to accept the preference similar node is determined by examining restrictions in the performance of the target device that is stored on the rule basis. When it is determined that the performance can accept the adaptation setting in the step (S40) of determining whether a device can accept adaptation setting, the process proceeds to the step (S50) of determining whether to satisfy an environmental context. If not, the process returns to the preference similar node selecting step (S30) to select a preference similar node having the next highest preference similarity following the previous preference similar node.

In the step (S50) of determining whether to satisfy an environmental context, it is determined whether the preference similar node, which has been determined to be accepted by the target device dimension, satisfies the environmental contexts, such as a file size and a network bandwidth. Whether the preference similar node satisfies the environmental contexts is determined by examining the environmental contexts that are stored on the rule basis. When it is determined that the preference similar node satisfies the environmental contexts in the step (S50) of determining whether to satisfy the environmental context, true decision is transmitted to the data converter, and the process proceeds to the data adaptation step (S60). If not, the process returns to the preference similar node selecting step (S30) to select a preference similar node having the third highest preference similarity following the previous preference similar node. It is preferable that the preference similar node selecting step (S30), the step (S40) of determining whether a device can accept adaptation setting, and the step (S50) of determining whether to satisfy the environmental context be repeated in a loop until the restriction conditions are satisfied.

The data adaptation step (S60) selects a data converter suitable for the adaptation setting of the preference similar node that satisfies the step (S50) of determining whether to satisfy the environmental context, thereby converting data. The converted data is transmitted to the user device that has requested the file.

Although the present invention has been described in connection with the exemplary embodiments of the present invention, it will be apparent to those skilled in the art that various modifications and changes may be made thereto without departing from the scope and spirit of the invention. Therefore, it should be understood that the above embodiments are not limitative, but illustrative in all aspects. The scope of the present invention is defined by the appended claims rather than by the description preceding them, and all changes and modifications that fall within meets and bounds of the claims, or equivalences of such meets and bounds are therefore intended to be embraced by the claims.

The invention can be used for a data adaptation service for file sharing between different kinds of platforms in a ubiquitous-based multi-party advanced collaboration environment by including user preference in adaptation conditions for data exchange in a remote collaboration environment to improve user satisfaction. Further, the invention can be widely applied to real-time file sharing, in addition to a remote collaboration system.

What is claimed is:

1. A user preference-based data adaptation service system that receives an original file and converts the original file, comprising:
a storage that stores user profile parameters including a user preference value, device profile information, and environmental context information;
a decision engine that reads the user preference value from the storage to generate preference similar nodes, arranges the preference similar nodes according to preference similarity values, and determines a preference similar node that has the highest preference similarity value while satisfying the device profile information and the environmental context information; and
a data converting unit that converts the original file according to the preference similar node determined by the decision engine.

2. The user preference-based data adaptation service system of claim 1,
wherein the decision engine includes:
a user preference value reading unit that reads the user preference value stored in the storage beforehand;
a preference similar node generating unit that generates the preference similar nodes from the user preference value read by the user preference value reading unit, and arranges the preference similar nodes in descending order of the preference similarity values; and
a preference similar node selecting unit that selects the preference similar node having the highest preference similarity among the preference similar nodes that are arranged in the descending order of the preference similarity values by the preference similar node generating unit.

3. The user preference-based data adaptation service system of claim 2,
wherein the decision engine further includes:
a first determining unit that determines whether the performance of a target device can accept the adaptation setting of a specific preference similar node selected by the preference similar node selecting unit.

4. The user preference-based data adaptation service system of claim 2,
wherein the decision engine further includes:
a second determining unit that determines whether the preference similar node selected by the preference similar node selecting unit satisfies the environmental contexts.

5. The user preference-based data adaptation service system of claim 2,
wherein the preference similar node generating unit includes:
a user preference calculating unit that calculates a user preference from the user preference value;
a adaptation setting preference calculating unit that generates all available preference similar nodes from each quality dimension according to the quality value, and calculates adaptation setting preferences of all of the generated preference similar nodes using the quality value;
a preference similarity calculating unit that calculates the preference similarities of all the preference similar nodes from the user preference calculated by the user preference calculating unit and the adaptation setting preference calculated by the adaptation setting preference calculating unit; and
a preference similar node arranging unit that arranges all the preference similar nodes in the descending order of the preference similarity on the basis of the preference similarity calculated by the preference similarity calculating unit.

6. The user preference-based data adaptation service system of claim 5,
wherein the preference similarity calculating unit calculates an angle formed between a vector indicating the user preference and a vector indicating the adaptation setting preference as the preference similarity.

7. A method of providing a user preference-based data adaptation service that receives an original file and converts the original file, the method comprising:
(a) allowing a user to input a user preference value for each quality dimension;
(b) calculating a user preference from the input user preference value to generate preference similar nodes, calculating the preference similarity of each preference similar node, and arranging the preference similar nodes in descending order of the preference similarity; and
(c) selecting a preference similar node having the highest preference similarity among the generated and arranged preference similar nodes.

8. The method of claim 7, further comprising:
(d) determines whether the performance of a target device can accept the adaptation setting of the selected preference similar node.

9. The method of claim 8, further comprising:
when it is determined that the performance of the target device does not accept the adaptation setting of the selected preference similar node, returning to the selecting of the preference similar node to select a preference similar node having the next highest preference similarity; and
repeating the (d) step.

10. The method of claim 7, further comprising:
(e) determining whether the preference similar node, which has been determined to be accepted by the target device, satisfies an environmental context.

11. The user preference-based data adaptation service system of claim 3,
wherein the decision engine further includes:
a second determining unit that determines whether the preference similar node selected by the preference similar node selecting unit satisfies the environmental contexts.
